(19) United States
(12) Patent Application Publication
(10) Pub. No.: US 2021/0154900 A1
(43) Pub. Date: May 27, 2021

(54) FEEDING DEVICE FOR INJECTION MOLDING MACHINE AND FEEDING METHOD USING THE FEEDING DEVICE

(71) Applicant: Hsui-Feng WEN, Taichung City (TW)

(72) Inventor: Hsui-Feng WEN, Taichung City (TW)

(21) Appl. No.: 16/820,934

(22) Filed: Mar. 17, 2020

(30) Foreign Application Priority Data
Nov. 21, 2019 (TW) 108142332

(51) Int. Cl. B29C 45/18; B29C 45/17; B29C 45/47; B29C 45/63

(52) U.S. Cl. CPC B29C 45/18; B29C 45/1775; B29C 2045/1875; B29C 45/63; B29C 45/47

(57) ABSTRACT

A feeding device for an injection molding machine adapted to feed a plastic material includes a bin unit, a valve unit and a conveying unit. The bin unit has an intake space and first and second spaces arranged sequentially along a path. The conveying unit has a mixer space communicating with the second space and includes a screw rod rotating therein to extrude the plastic material out of the mixer space while gases in the plastic material are pumped out through a gas discharge channel. The valve unit includes first and second valves which are respectively disposed between the intake and first spaces and between the first and second spaces, and are alternately movable to a close position to provide an airtight seal upstream of the mixer space.

### CROSS-REFERENCE TO RELATED APPLICATION

This application claims priority of Taiwanese Invention Patent Application No. 108142332, filed on Nov. 21, 2019.

### FIELD

The disclosure relates to a feeding device, more particularly to a feeding device for an injection molding machine.

### BACKGROUND

Referring to FIG. 1, a conventional injection molding machine includes a feeding device 11 and a forming device 12 disposed downstream of the feeding device 11. The feeding device 11 includes a feed hopper 111, a heating tube unit 112 connected downstream of the feed hopper 111, and an extruder screw 113 extending rotatably along the heating tube unit 121.

To operate the conventional injection molding machine, plastic pellets 13 are poured into the feed hopper 111, enters the heating tube unit 121 through the feed hopper 111, and is melted into a plastic paste (not shown). Then, the extruder screw 113 is rotated to drive the plastic paste to be extruded into the forming device 12 for further processing.

However, as the plastic paste is blended, gaseous substances released from polymers and air entering through the feed hopper 111 may be blended into the plastic paste. Thus, gas bubbles are formed in the finished product formed by the forming device 12 and adversely affect the quality of the finished product.

### SUMMARY

Therefore, the object of the disclosure is to provide a feeding device that can alleviate at least the drawback of the prior art.

According to the disclosure, a feeding device for an injection molding machine adapted to feed a plastic material along a feeding path therein is provided. The feeding device includes a bin unit, a valve unit and a conveying unit. The bin unit includes an intake module, a first bin module and a second bin module. The intake module has an intake space adapted to receive the plastic material therein. The first bin module includes a first bin body defining a first space. The second bin module includes a second bin body defining a second space. The intake module, the first bin module and the second bin module are arranged sequentially along the feeding path. The valve unit includes a first vale module and a second valve module. The first valve module is disposed between the intake space and the first space, and is operable between an open position, where the intake space is in fluid communication with the first space, and a close position, where the intake space is isolated airtightly from the first space. The second valve module is disposed between the first space and the second space and is operable between an open position, where the first space is in fluid communication with the second space and a close position, where the first space is isolated airtightly from the second space. The conveying unit includes a mixer bin that is connected airtightly to a downstream portion of the second bin body and that defines a mixer space in fluid communication with the second space, a gas discharge channel that is in fluid communication with the mixer space and that is adapted to be connected to a suction pump so that gases can be pumped out from the mixer space through the gas discharge channel, and a screw rod that is rotatably disposed in the mixer space and that is adapted to extrude the plastic material outwardly from the mixer space.

According to another aspect of the present disclosure, a feeding method using the feeding device is provided. The method includes:

delivering the plastic material into the mixer space of the conveying unit through the intake space, the first valve module, the first space, the second valve module, and the second space;

heating the plastic material in the mixer space to melt the same;

rotating the screw rod to extrude the plastic material outwardly from the mixer space while gases are pumped out from the mixer space through the gas discharge channel;

providing an airtight seal upstream of the mixer space of the conveying unit during rotating the screw rod by alternately moving the first and second valve modules to the close position in such a manner that, when one of the first and second valve modules is in the close position to form the airtight seal, the other one of the first and second valve modules is in the open position to allow passage of the plastic material; and

temporarily storing the plastic material in the first space when the second valve module is in the close position and the first valve module is in the open position, and subsequently delivering the plastic material stored in the first space to the second space when the second valve module is moved to the open position and the first valve module is moved to the close position.

### BRIEF DESCRIPTION OF THE DRAWINGS

Other features and advantages of the disclosure will become apparent in the following detailed description of the embodiment with reference to the accompanying drawings, of which:

FIG. 1 is a schematic side view of a conventional injection molding machine;

FIG. 2 is a schematic sectional view of an embodiment of a feeding device for an injection molding machine according to the present disclosure;

FIG. 3 is partial magnified view of FIG. 2;

FIG. 4 is a block diagram of a valve unit, a detecting unit, and a control unit of the embodiment of the feeding device, illustrating the control unit connected to the valve unit and the detecting unit; and

FIGS. 5A to 5F are schematic sectional views of the embodiment, illustrating an operating procedure for feeding a plastic material along a feeding path in the feeding device.

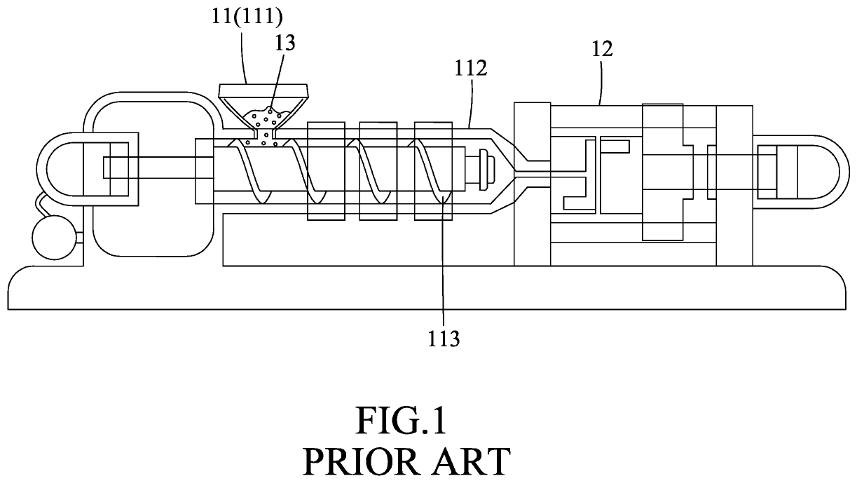

### DETAILED DESCRIPTION

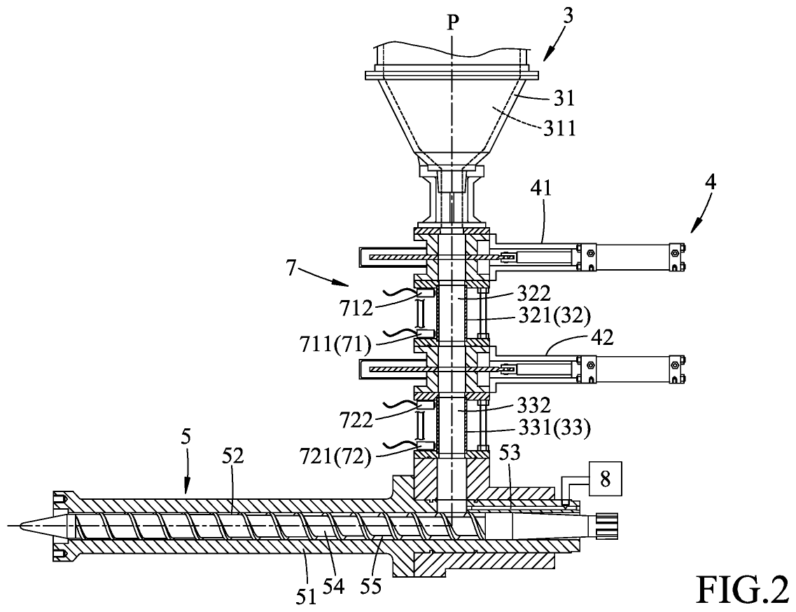

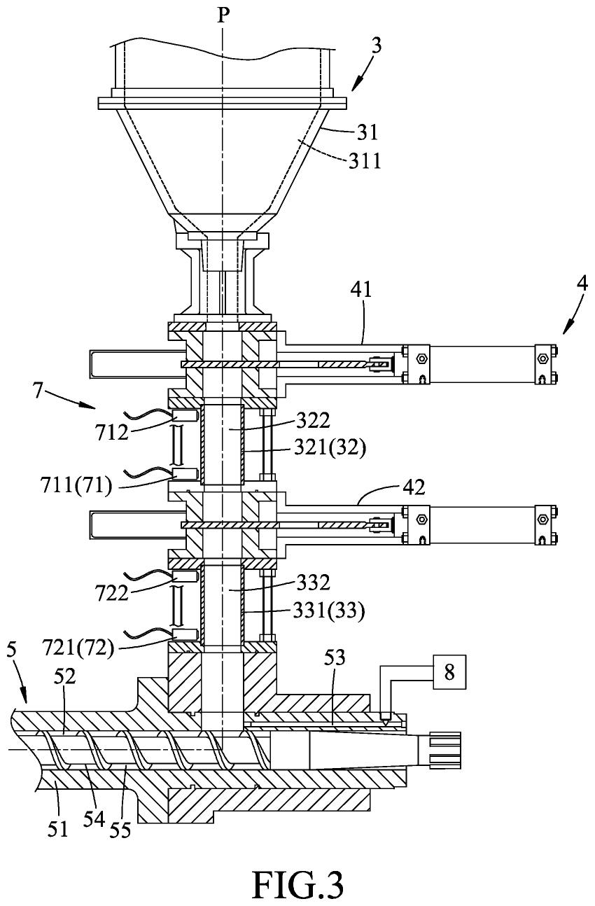

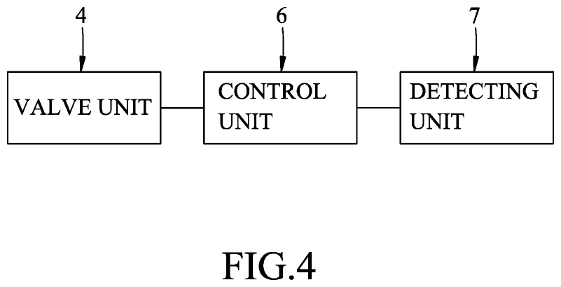

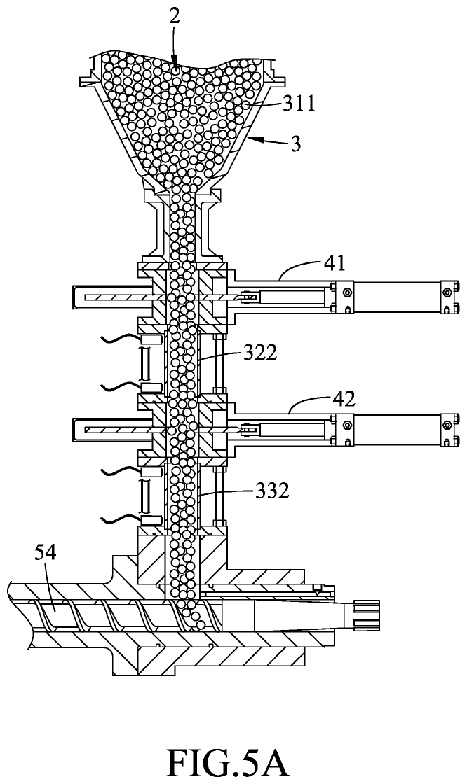

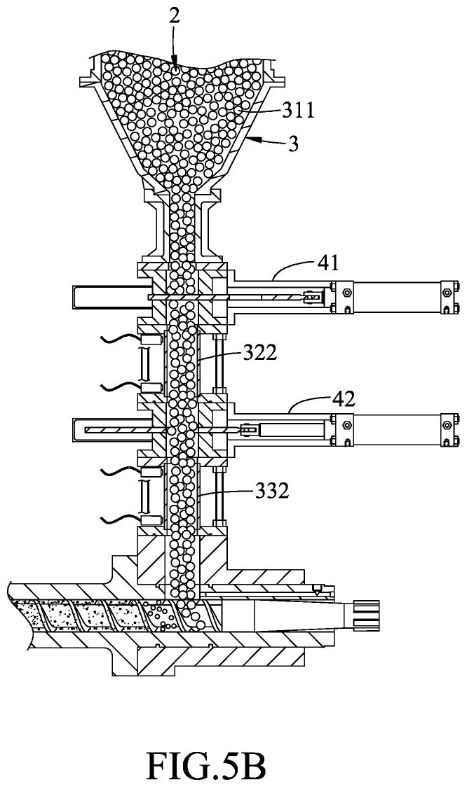

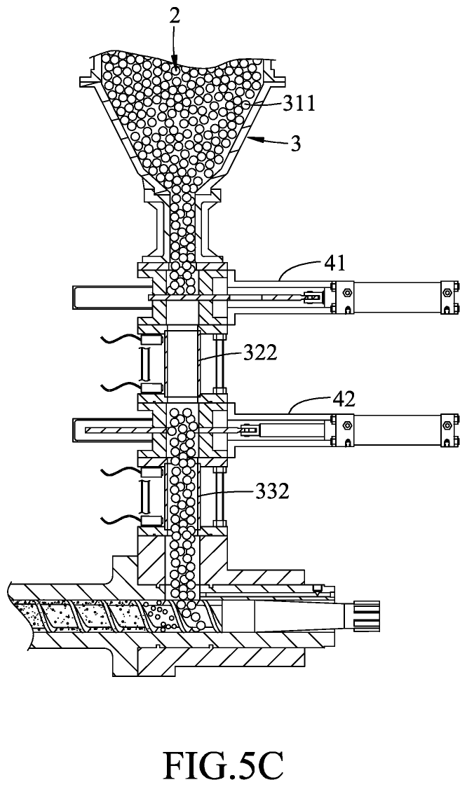

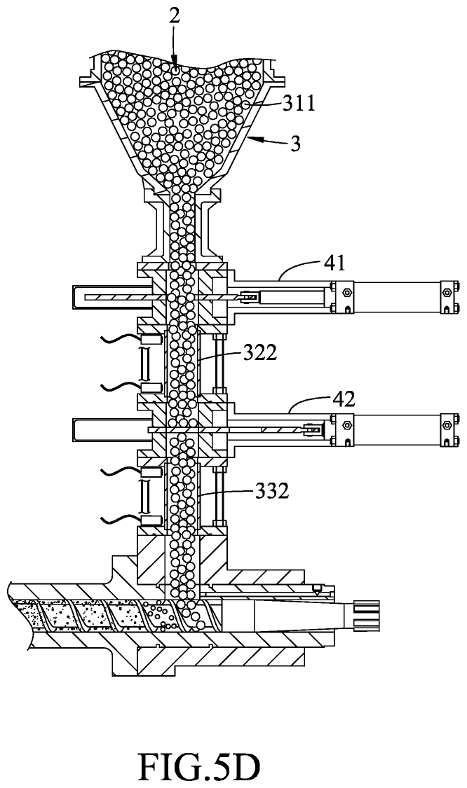

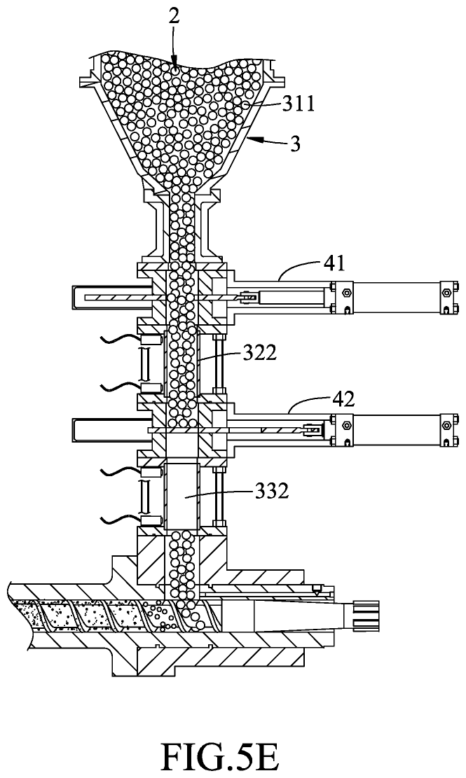

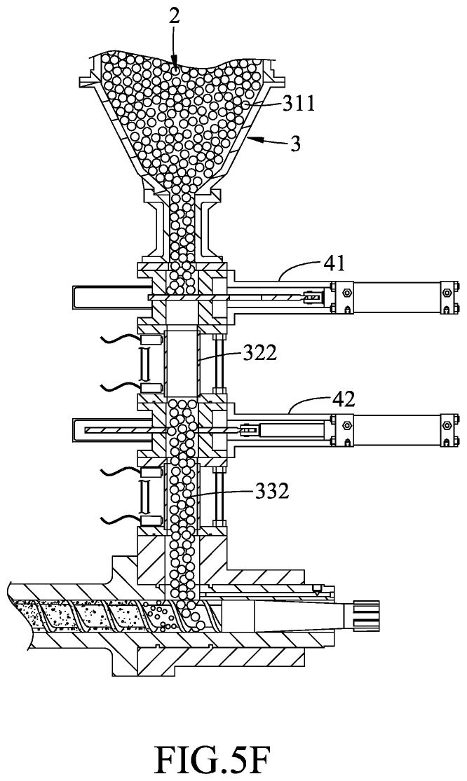

Referring to FIGS. 2, 3, and 4, an embodiment of a feeding device for an injection molding machine adapted to feed a plastic material 2 (see FIGS. 5 (A) to 5 (F)) along a feeding path (P) therein is shown. The feeding device includes a bin unit 3, a valve unit 4, a conveying unit 5, a control unit 6, a detecting unit 7 and a suction pump 8.

The bin unit 3 includes an intake module 31, a first bin module 32 and a second bin module 33 arranged sequentially along the feeding path (P). The intake module 31 has an intake space 311 adapted to receive the plastic material 2 therein. The first bin module 32 includes a first bin body 321 defining a first space 322. The second bin module 33 includes a second bin body 331 defining a second space 332.

The valve unit 4 includes a first valve 41 and a second valve 42. The first vale module 41 is disposed between the intake space 311 and the first space 322, and is operable between an open position, where the intake space 311 is in fluid communication with the first space 322 and a close position, where the intake space 311 is isolated airtightly from the first space 322. The second valve module 42 is disposed between the first space 322 and the second space 332, and is operable between an open position, where the first space 322 is in fluid communication with the second space 332 and a close position, where the first space 322 is isolated airtightly from the second space 332. In this embodiment, the first valve module 41 and the second valve module 42 can be, but are not limited to, pneumatic control valves.

The conveying unit 5 includes a mixer bin 51, a gas discharge channel 53, a screw rod 54, and a heating tube 55. The mixer bin 51 is connected airtightly to a downstream portion of the second bin body 331 along the feeding path (P) and defines a mixer space 52 in fluid communication with the second space 332. The gas discharge channel 53 is connected to the first mixer bin 51, is in fluid communication with the mixer space 52, and is adapted to be connected to the suction pump 8 so that gases can be pumped out from the mixer space 52 through the gas discharge channel 53. The screw rod 54 is rotatably disposed in the mixer space 52 and is adapted to extrude the plastic material 2 melted by the heating tube 55 outwardly from the mixer space 52.

The detecting unit 7 includes a first detecting module 71 and a second detecting module 72. The first detecting module 71 is disposed at the first bin body 321, and includes a first empty space detector 711 and a first full capacity detector 712. The second detecting module 72 is disposed at the second bin body 331, and includes a second empty space detector 721 and a second full capacity detector 722. In this embodiment, each of the first empty space detector 711, the second empty space detector 721, the first full capacity detector 712 and the second full capacity detector 722 can be, but is not limited to, a photoelectric sensor.

The first empty space detector 711 is configured to detect the amount of the plastic material 2 present in the first space 322. Specifically, the first empty space detector 711 detects whether a first content capacity currently received in the first space 322 is less than a first predetermined capacity. In this embodiment, the first empty space detector 711 is disposed proximate to the second valve module 42 and is configured to detect whether the first space 322 is empty of the plastic material (see FIG. 5C). The first full capacity detector 712 is disposed distal from the second valve module 42 and is configured to detect whether the first space 322 is full of the plastic material.

Similarly, the second empty space detector 721 is configured to detect the amount of the plastic material 2 present in the second space 332. Specifically, the second empty space detector 721 detects whether a second content capacity currently received in the second space 332 is less than a second predetermined capacity. In this embodiment, the second empty space detector 721 is disposed proximate to the mixer bin 51 and is configured to detect whether the second space 332 is empty of the plastic material 2 (see FIG. 5E). The second full capacity detector 722 is disposed distal from the mixer bin 51 and is configured to detect whether the second space 332 is full of the plastic material 2.

The control unit 6 is electrically connected to the valve unit 4 and the detecting unit 7, and is configured to control the first valve module 41 and the second valve module 42 to alternately move to the close or open position according to the results provided by the detecting unit 7. Specifically, the control unit 6 is configured to control the second valve module 42 to move to the close position and the first valve module 41 to move to the open position when the first empty space detector 711 of the first detecting module 71 detects that the first space 322 is empty so that the plastic material 2 is delivered from the intake space 311 to the first space 322 (see FIG. 5D).

The control unit 6 also controls the first valve module 41 to move to the close position and the second valve module 42 to move to the open position when the second empty space detector 721 of the second detecting module 72 detects that the second the second space 332 is empty so that the plastic material 2 is delivered from the first space 322 to the second space 332 (see FIG. 5F).

Additionally, the control unit 6 is configured to output an alert signal when one of the following conditions is satisfied:

when the first full capacity detector 712 detects that the first space 322 is full, but the first empty detector 711 detects that the first space 322 is empty;

when the second full detector 722 detects that the second space 332 is full, but the second empty detector 721 detects that the second space 332 is empty;

when the first full space detector 712 fails to detect that the first space 322 is full after the first valve module 41 is moved to the open position for a predetermined time period; and

when the first empty space detector 711 and the second empty space detector 721 respectively detect that the first space 322 and the second space 332 are both empty.

Note that the control unit 6 may be implemented with a microprocessor, a micro control unit (MCU), or any circuit configurable/programmable in a software manner and/or hardware manner to perform functionalities of this disclosure. In this embodiment, the alert signal outputted by the control unit 6 may be, for example, a sound and/or light, and the control unit 6 may include a display, a light, a speaker or any other output devices capable of outputting an alert signal and the implementation of the control unit 6 is not limited to the examples described herein.

In one embodiment of the present disclosure, a feeding method using the feeding device is provided and includes following steps.

In step 1, the feeding device delivers the plastic material 2 into the mixer space 52 of the conveying unit 5 sequentially through the intake space 311, the first valve module 41, the first space 322, the second valve module 42, and the second space 332. Specifically, as shown in FIG. 5A, the first and second valve modules 41, 42 are both moved to the open position to allow the plastic material 2 to be delivered into the mixer space 52 through the intake space 311, the first space 322 and the second space 332.

In step 2, the heating tube 55 of the conveying unit 5 heats the plastic material 2 in the mixer space 52 to melt the plastic material 2 into plastic paste.

In step 3, the screw rod 54 rotates to extrude the plastic paste outwardly from the mixer space 52 while the suction pump 8 pumps gases out from the mixer space 52 through the gas discharge channel 53.

In step 4, as shown in FIGS. 5B-5F, the feeding device provides an airtight seal at upstream of the mixer space 52 of the conveying unit 5 by alternately moving the first and second valve modules 41, 42 to the close position in such a manner that, when one of the first and second valve modules 41, 42 is in the close position to form the airtight seal, the other one of the first and second valve modules 41, 42 is in the open position to allow passage of the plastic material 2 along the feeding path (P). In this embodiment, the first empty space detector 711 of the detecting unit 7 detects the amount of the plastic material present at a downstream side of the first valve module 41, the second empty space detector 721 detects the amount of the plastic material 2 present at a downstream side of the second valve module 42, and the control unit 6 controls the first and second valve modules 41, 42 to alternately move to the close or open position according to the detecting results provided by the detecting unit 7. Note that, in this embodiment, steps 2 and 3 are performed simultaneously while step 4 is performed.

As illustrated in FIG. 5B, the control unit 6 controls the first valve module 41 to move to the close position when the first full capacity detector 712 and the second full capacity detector 722 respectively detected that the first space 322 and the second space 332 are full. At this time, the feeding device temporarily stores the plastic material 2 in the intake space 311 and delivers the plastic material 2 in the first space 322 to the second space 332.

As shown in FIGS. 5 C and 5 D, the control module 6 controls the second valve module 42 to move to the close position and the first valve module 41 to move to the open position (see FIG. 5 D) when the first empty space detector 711 detects that no plastic material 2 is in the first space 322, i.e., the first space 322 is empty (see FIG. 5C). Thus, the feeding device delivers the plastic material 2 in the intake space 311 to the first space 322, and the feeding device temporarily stores the plastic material 2 in the first space 322 when the second valve module 42 is in the close position and the first valve module 41 is in the open position.

Subsequently, as shown in FIG. 5 F, the control module 6 controls the second valve module 42 to move to the open position and the first valve module 41 to move to the close position when the second empty space detector 721 detects that no plastic material 2 is in the second space 322, i.e., the second space 322 is empty (see FIG. 5 E). As such, the feeding device delivers the plastic material 2 in the first space 322 to the second space 322 and temporarily stores the plastic material 2 in the intake space 311 when the second valve module 42 is in the open position and the first valve module 41 is in the close position.

During performing the feeding method, the control unit 6 outputs an alert signal when the first full space detector 712 fails to detect that the first space 322 is full after the first valve module 41 is moved to the open position for a predetermined time period. Such circumstance indicates that no plastic material 2 is present in the intake space 311, and the alert signal is provided to notify a user to check the feeding device, and/or to supplement the plastic material 2.

When the first full capacity detector 712 detects that the first space 322 is full, but the first empty space detector 711 detects that the first space 322 is empty, the alert signal outputted from the control unit 6 may indicate that the feeding path (P) jams as the plastic material 2 is stuck in the first space 322 at a position adjacent to the first valve module 41 the first space 322.

When the second full capacity detector 722 detects that the second space 332 is full, but the second empty space detector 721 detects that the second space 332 is empty, the alert signal outputted by the control unit may indicate that the plastic material 2 is stuck in the second space 332 at a position adjacent to the second valve module 42.

When the first empty space detector 711 and the second empty space detector 721 respectively detect that the first space 322 and the second space 332 are both empty, the alert signal of the control unit 6 notifies the user to check the status of the feeding device.

Although the control unit 6 controls the first valve module 41 and the second valve module 42 to alternately move to the close or open position according to the results provided by the detecting unit 7 in this embodiment, in other embodiments, the first valve module 41 and the second valve module 42 may be controlled by a servomotor to alternately move to the close or open position at predetermined time intervals.

In sum, by alternately controlling the first valve module 41 and the second valve module 42 to move to the close or open position, an airtight seal can be provided upstream of the mixer space 52 without interrupting passage of the plastic material 2 through the intake, first and second spaces 311, 322, 332 and the first and second valve modules 41, 42. Therefore, the plastic material 2 can be fed into the mixer space 52 continuously without interruption when the screw rod 54 rotates to extrude the plastic material 2 outwardly from the mixer space 52. In addition, because of the airtight seal provided upstream of the mixer space 52, air and gases in the mixer space 52 can be efficiently pumped out, and air bubbles formed in the extruded products can be reduced, thereby improving the quality of a finished product.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A feeding device for an injection molding machine adapted to feed a plastic material along a feeding path therein, said feeding device comprising:
a bin unit including an intake module that has an intake space adapted to receive the plastic material therein, a first bin module that includes a first bin body defining a first space, and a second bin module that includes a second bin body defining a second space, said intake module, said first bin module and said second bin module being arranged sequentially along the feeding path;
a valve unit including
a first vale module that is disposed between said intake space and said first space, and that is operable between an open position, where said intake space is in fluid communication with said first space and a close position, where said intake space is isolated airtightly from said first space, and
a second valve module that is disposed between said first space and said second space, and that is operable between an open position, where said first space is in fluid communication with said second space and a close position, where said first space is isolated airtightly from said second space; and
a conveying unit including a mixer bin that is connected airtightly to a downstream portion of said second bin body and that defines a mixer space in fluid communication with said second space, a gas discharge channel that is in fluid communication with said mixer space and that is adapted to be connected to a suction pump so that gases can be pumped out from said mixer space through said gas discharge channel, and a screw rod that is rotatably disposed in said mixer space and that is adapted to extrude the plastic material outwardly from said mixer space.

2. The feeding device as claimed in claim 1, further comprising a control unit and a detecting unit, said control unit electrically connected to said valve unit and said detecting unit, said detecting unit including a first detecting module disposed at said first bin body and configured to detect whether a first content capacity currently received in said first space is less than a first predetermined capacity, and a second detecting module disposed at said second bin body and configured to detect whether a second content capacity currently received in said second space is less than a second predetermined capacity, said control unit controlling said second valve module to move to the close position and said first valve module to move to the open position when said first detecting module detects that the first content capacity is less than the first predetermined capacity so that the plastic material is delivered from said intake space to said first space, said control unit controlling said first valve module to move to the close position and said second valve module to move to the open position when said second detecting module detects that the second content capacity is less than the second predetermined capacity so that the plastic material is delivered from said first space to said second space.

3. The feeding device as claimed in claim 2, wherein said first detecting module of said detecting unit includes a first empty space detector disposed proximate to said second valve module and configured to detect whether said first space is empty, said second detecting module including a second empty space detector disposed proximate to said mixer bin and configured to detect whether said second space is empty.

4. The feeding device as claimed in claim 3, wherein said first detecting module includes a first full capacity detector disposed distal from said second valve module and configured to detect whether said first space is full, said second detecting module including a second full capacity detector disposed distal from said mixer bin and configured to detect whether said second space is full.

5. The feeding device as claimed in claim 4, wherein said control unit is configured to output an alert signal when said first full capacity detector detects that said first space is full, but said first empty detector detects that said first space is empty, and to output an alert signal when said second full detector detects that said second space is full, but said second empty detector detects that said second space is empty.

6. The feeding device as claimed in claim 4, wherein each of said first empty space detector, said second empty space detector, said first full capacity detector and said second full capacity detector is a photoelectric sensor.

7. The feeding device as claimed in claim 1, wherein each of said first valve module and said second valve module is a pneumatic valve.

8. A feeding method using the feeding device according to claim 1, the method comprising:
delivering the plastic material into the mixer space of the conveying unit through the intake space, the first valve module, the first space, the second valve module, and the second space;
heating the plastic material in the mixer space to melt the same;
rotating the screw rod to extrude the plastic material outwardly from the mixer space while gases are pumped out from the mixer space through the gas discharge channel;
providing an airtight seal upstream of the mixer space of the conveying unit during rotating the screw rod by alternately moving the first and second valve modules to the close position in such a manner that, when one of the first and second valve modules is in the close position to form the airtight seal, the other one of the first and second valve modules is in the open position to allow passage of the plastic material; and
temporarily storing the plastic material in the first space when the second valve module is in the close position and the first valve module is in the open position, and subsequently delivering the plastic material stored in the first space to the second space when the second valve module is moved to the open position and the first valve module is moved to the close position.

9. The method as claimed in claim 8, wherein the plastic material is delivered from the first space to the second space and from the second space to the mixer space when the second valve module is in the open position and when the first valve module is moved to the close position to provide the airtight seal; and
the plastic material is delivered from the intake space to the first space when the first valve module is in the open position and when the second valve module is moved to the close position to provide the airtight seal.

10. The feeding method as claimed in claim 8, the feeding device further including a control unit and a detecting unit, the detecting unit detecting the amount of the plastic material present at a downstream side of the first valve module and the amount of the plastic material present at a downstream side of the second valve module, the control unit controlling the first and second valve modules to alternately move to the close or open position according to the results provided by the detecting unit.

11. The feeding method as claimed in claim 10, wherein the detecting unit detects the amount of the plastic material present in the first space disposed between the first and second valve modules and the amount of the plastic material present in the second space disposed between the second valve module and the mixer space, and the control unit controls the first valve module to move to the open position and the second valve module to move to the close position when no plastic material is in the first space and controls the first valve module to move to the close position and the second valve module to move to the open position when no plastic material is in the second space.

12. The feeding method as claimed in claim 11, wherein the control unit outputs an alert signal when the detecting unit detects that the first or second space is empty.

13. The feeding method as claimed in claim 7, the detecting unit including a first full capacity detector, a first empty space detector, a second full capacity detector and a second empty space detector, the control unit outputting an alert signal when one of the following conditions is satisfied:
when the first full capacity detector detects that the first space is full, but the first empty space detector detects that the first space is empty, and when the second full capacity detector detects that the second space is full, but the second empty space detector detects that the second space is empty.

14. The feeding method as claimed in claim 13, wherein the control unit outputs an alert signal when the first full space detector fails to detect that the first space is full after the first valve module is moved to the open position for a predetermined time period.
